(19) United States
(12) Patent Application Publication
(10) Pub. No.: US 2002/0165082 A1
(43) Pub. Date: Nov. 7, 2002

(54) Radiation shielding phosphate bonded ceramics using enriched isotopic boron compounds

(76) Inventors: Dileep Singh, Naperville, IL (US); Seung-Young Jeong, Westmont, IL (US)

Correspondence Address: CHERSKOV & FLAYNIK, THE CIVIC OPERA BUILDING, 20 NORTH WACKER DRIVE, SUITE 1447, CHICAGO, IL, 60606, US

(21) Appl. No.: 09/791,422

(22) Filed: Feb. 23, 2001

(51) Int. Cl. C04B 35/00; G21F 9/00; C04B 35/447

(52) U.S. Cl. 501/155; 588/3

(57) ABSTRACT

A new method for enhancing the physical and radiation shielding characteristics of phosphate ceramics, via the incorporation therein of isotopic boron compounds and bismuth, iron, and lead additives. The resulting material finds applications as physical and radiation shields and as building constituents in spent fuel- and waste containment-scenarios.

### CONTRACTUAL ORIGIN OF INVENTION

The United States Government has rights in this invention pursuant to Contract No. W-31-109-ENG-38 between the U.S. Department of Energy and the University of Chicago, representing Argonne National Laboratory.

### BACKGROUND OF THE INVENTION

1. Field of the Invention

This invention relates to a radiation shielding ceramic substrate and a process to produce radiation shielding, and more specifically, this invention relates to a method for manipulating phosphate ceramics to produce radiation shielding material and components for spent fuel- and waste containment-systems.

2. Background of the Invention

Low-level mixed wastes contain hazardous chemical and low-level radioactive materials. Of particular concern are low-level mixed waste streams that contain heavy metals, such as lead, cadmium, copper, zinc, nickel, and iron among others, and waste streams from nuclear materials processing applications that contain technetium-99, chromium, and antimony.

Methods have been developed for producing structural materials and products by binding benign wastes with a ceramic binder. These methods have also been applicable to producing near term containment materials. These methods and materials are disclosed in U.S. pat. No. 5,830,815. This material, commonly known as Ceramicrete™ has significant amounts of bound water and can accommodate boric acid. However, Ceramicrete has limited thermal conductivity. For example, for spent fuel or other high radiation environment, it is necessary to have high thermal conductivity for heat dissipation. As such, the applicability of Ceramicrete in those scenarios is limited

U.S. Pat. No. 5,830,815 issued to Wagh et. al. on Nov. 3, 1998 discloses a method for waste stabilization using chemically bonded phosphate ceramics. U.S. Pat. No. 6,133,498 issued to Singh et. al. on Oct. 17, 2000 discloses a method for producing chemically bonded phosphate ceramics and for stabilizing contaminants encapsulated therein utilizing reducing agents. Neither of these two patents disclose any method for imparting radiation and/or thermal shielding to ceramic materials.

A need exists in the art for structural containment materials which can be used as radiation and thermal shielding material and also to facilitate spent fuel and waste containment. A need also exists for a method for producing these materials. Some of the applications for these materials are casks for transportation and storage of spent fuel, in-situ stabilization of buried wastes, nuclear accident and waste spillage sites for remediation (e. g., Chernobyl sarcophagus), and medical applications.

### SUMMARY OF INVENTION

An object of the present invention is to provide methods to enhance the physical and radiation shielding characteristics of chemically bonded phosphate ceramics that overcomes many of the disadvantages of the prior art.

Another object of the present invention is to provide a substrate which exhibits in-situ or ex-situ shielding against neutrons and gamma radiation. A feature of the invention is that the substrate comprises metal homogeneously dispersed in ceramic material, thereby making the resulting metal-ceramic slurry readily castable and inexpensive. An advantage of this is that the material can be easily and quickly produced and put into place for use.

Still another object of the present invention is to provide a method for imparting neutron absorption by phosphate-based ceramics. A feature of the invention is that metallic substrate, such as boron-containing metals, are homogeneously mixed with the binder of the ceramic prior to curing. Instead of natural boron, boron isotopes such as boron-10 are used to improve the neutron absorption. An advantage of using heavier isotopes is that their nuclear cross-section areas (i.e., their means for capturing neutrons) is enhanced, compared to natural boron.

Yet another object of the present invention is to provide alternative substances to improve the neutron absorption of boron-doped ceramic systems. A feature of the invention is that bismuth and iron compounds, and elemental lead are used to improve the gamma radiation absorption. An advantage of this feature is that nuclear cross-section areas are larger for these heavy metals than for many other metals, thereby serving as a means for improving neutron absorption and therefore gamma radiation absorption of the substance.

Still another object of the present invention is to provide a method to improve the physical shielding characteristics of ceramic. A feature of the invention is that bismuth and iron compounds, and elemental lead are used to augment the ceramic's density. An advantage of this is that the ceramic will more readily withstand physical shock and thus more safely retain the hazardous materials within.

Yet another object of the present invention is to provide a method to improve the heat shielding characteristics of the ceramic. A feature of the invention is that metal (such as boron-doped aluminum) is homogeneously mixed with ceramic slurry prior to curing. Alternatively, longer metal substrates are inserted into the ceramic slurry prior to the ceramic curing so that each of the substrates or fibers extend in generally the same direction. An advantage of this is that the ceramic will more readily dissipate heat as the metal acts as heat sinks and heat conduits.

Briefly the invention provides a method for enhancing the physical and radiation shielding characteristics of phosphate ceramics comprising providing a slurry of a ceramic liquor; adding boron to the liquor; and allowing the liquor to cure.

The invention also provides a ceramic substrate comprising a binder further comprising magnesium, potassium, and phosphorus; a means for dissipating heat, said means contacting said binder; and a means for shielding radiation, said shielding means connecting said binder.

### BRIEF DESCRIPTION OF THE DRAWING

The present invention together with its objects and advantages may best be understood from the following detailed description of the embodiment of the invention illustrated in the drawing, wherein:

FIG. 1 is a perspective cut-away of an exemplary ceramic-metallic substrate, in accordance with features of the present invention.

### DETAILED DESCRIPTION OF THE INVENTION

This invention teaches a method for enhancing the physical and radiation shielding characteristics of chemically bonded phosphate ceramics by use of metallic reinforcements and heavy metal additions. Generally, the inventors have found that certain metallic additions to ceramics impart neutron absorption capability to the resulting ceramic monolith. The process modifications disclosed herein are vital for rendering phosphate ceramics as a radiation shielding material and as construction matrices for use in spent fuel- and waste-containment scenarios.

Generally, the invention teaches the addition of neutron absorbers to ceramic systems. Both water and heavy metals such as boron (and particularly boron isotopes) act as neutron absorbers. This is because nuclear cross-section areas are much larger for boron isotopes such as boron-10 than for natural boron. Natural boron is only 19.78 mole percent boron-10.

Specifically, the invention provides a method for integrating boron-10 (¹⁰B₄C; isotopically enriched B₄C, >95% boron-10) into magnesium potassium phosphate with water, fly ash, hematite, magnetite, bismuth (III) oxide, and elemental lead to produce an inexpensive castable material for in-situ or ex-situ shielding against neutrons and gamma radiation. The boron-10 absorbs neutrons and the bound water in the ceramic further provides a means to attenuate neutrons. The hematite and magnetite provide a means to attenuate photons. The bismuth (III) oxide and elemental lead improve the density and the gamma-ray shielding properties of the ceramic.

Process detail

Ceramic formulations incorporating magnesium, potassium and phosphate binding systems are utilized as the starting material. The process for producing these starting materials is similar to those described in U.S. pat. No. 5,830,815 issued to Wagh et. al. and U.S. pat. No. 6,133,498 issued to Singh et al. Both of these patents are incorporated herein by reference.

Briefly, the radiation shielding ceramic is formulated via the following protocol: MgO and either phosphoric acid or an acid phosphate salt solution are mixed and reacted for at time sufficient to form a slurry, usually 0.5 hour.

Metallic substrate, such as, but not limited to, B₄C, Bi₂O_{3,} Fe₂O₃, Fe₃O₄, Pb metal, and/or small borated Al bars are added to the reaction mixture. After mixing is stopped, the slurry starts to thicken and sets into a hard and dense ceramic. The setting time is approximately 2 hours. These preparations have been carried out on a 55-gallon scale.

Metallic Substrate Detail

The B₄C, either natural or isotopic, can be present in a concentration range of 1 wt % to 20 wt % in the total reaction slurry. Similarly, Bi₂O₃ can be present as 1 wt % to 15 wt % Fe₂O₃ (sand) as 1 wt % to 35 wt %, Fe₃O₄ (gravel) as 1 wt % to 50 wt %), Pb metal (pieces/chunks) as 5 wt % to 50 wt %. Aluminum bars, both borated and unborated can be present in the slurry from 1 wt % to 20 wt %.

The boron isotopes are added to the ceramic slurry in a myriad of forms, including, but not limited to, enriched boric acid, boron carbide, and iron boride. The addition of the metallic substrates is facilitated with a Hobalt-type mixer or a concrete mixer. The density of the boron isotopes and the ceramic slurry are about the same and the resulting slurry achieves homogeneity without the metallic clusters aggregating due to gravity.

Some metallic substrates [Fe₂O₃ (sand), Fe₃O₄ (gravel), lead compounds, etc.] are so heavy that homogeneity is difficult to achieve. In these instances, the size and amount of metallic substrate is chosen to completely fill any final ceramic form, with ceramic binder and filler (such as fly ash) serving as mortar between the metallic substrates and as a covering over the metallic substrates.

Suitable metallic substrates can be a variety of different shapes and sizes, including such geometric shapes as rods, fibers, hollow cylinders, powder (−40 mesh to +200 mesh), sand (−40 mesh to +5 mesh), and gravel (−2 mesh to +5 mesh).

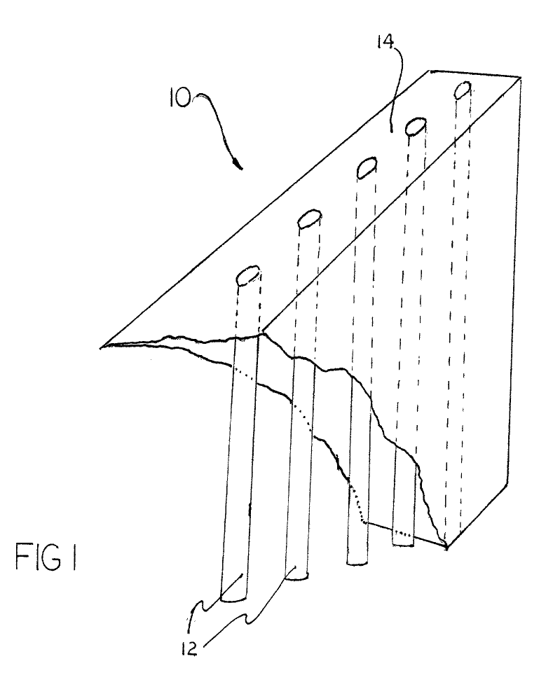

In some instances, metallic substrate are inserted into ceramic slurry in a predetermined configuration. For example, and as illustrated in FIG. 1, a unique substrate 10 results when elongated metallic objects are inserted into a ceramic slurry contained by a mold. The metallic objects illustrated in FIG. 1 are rods 12.

However, and as discussed supra, a myriad of other shapes are suitable. The rods 12 extend throughout the monolith, and are surrounded by phosphate ceramic constituents 14.

The rods 12 are arranged to extend generally in the same direction. In FIG. 1, the rods are arranged parallel with each other. This imparts added strength to the resulting substrate as well as a unified direction for heat dissipation. In the illustrated embodiment 10, the ends of the rods protrude from the final monolith form.

The ceramics are made with magnesium potassium phosphate (MKP), fly ash, Fe₂O₃ in the form of sand, Fe₃O₄ in the form of gravel, boron carbide (B₄C), water, and sometimes borated aluminum bars. The MKP can be present in the concentration range of 10 wt % to 60 wt %, the fly ash as 5 wt % to 50 wt %, Fe₂O₃ as 1 wt % to 35 wt %, Fe₃O₄ as 1 wt % to 50 wt %, boron carbide as 1 wt % to 20 wt %, water as 5 wt % to 30 wt %, and the aluminum bars as 1 wt % to 20 wt %.

A myriad of exemplary compositions have been formulated, and are discussed in Tables A-D below. However, these compositions are merely illustrative of the type which can be formulated given the ranges provided supra. As such these examples are not to be construed as limiting the scope of the invention. Also, it should be noted that the “sand” and “gravel” designations in the tables indicate the size of the moieties utilized. Generally, the “sand” and gravel designations comprise particles have mesh sizes as designated supra.

### EXAMPLES

A. Final compositions of samples made with natural B₄C (wt. %)

| MKP | Ash | Fe₂O₃ (sand) | Fe₃O₄ (gravel) | B₄C | H₂O |
|---|---|---|---|---|---|
| 15.35 | 14.35 | 30.73 | 30.73 | 1 | 7.84 |
| 15.35 | 11.25 | 30.73 | 30.73 | 4.1 | 7.84 |
| 11.75 | 10.75 | 23.5 | 46.99 | 1 | 6.02 |
| 11.75 | 7.65 | 23.5 | 46.99 | 4.1 | 6.02 |
| 39.84 | 38.84 | | | 1 | 20.32 |
| 39.84 | 35.74 | | | 4.1 | 20.32 |

B. Final compositions of samples made with natural B₄C (wt. %)

| | | | | | | Aluminum |
|---|---|---|---|---|---|---|
| MKP | Ash | Fe₂O₃ (sand) | Fe₃O₄ (gravel) | B₄C | H₂O | bar |
| 15.35 | 14.35 | 30.73 | 30.73 | 1 | 7.84 | 10.0 |
| 15.35 | 11.25 | 30.73 | 30.73 | 4.1 | 7.84 | 10.0 |
| 11.75 | 10.75 | 23.5 | 46.99 | 1 | 6.02 | 7.7 |
| 11.75 | 7.65 | 23.5 | 46.99 | 4.1 | 6.02 | 7.7 |

The aluminum bars were borated with elemental boron. The bars' boron content was 4.5 wt. % enriched elemental boron. The elemental boron was >95% ¹⁰B.

Additional samples were made with the direct addition of isotopically enriched B₄C. The isotopically enriched B₄C was also >95% ¹⁰B. Those samples' compositions are given in TABLES C and D.

C. Final compositions of samples made with enriched B₄C (wt. %)

| MKP | Ash | Fe₂O₃ (sand) | Fe₃O₄ (gravel) | B₄C | H₂O |
|---|---|---|---|---|---|
| 15.35 | 14.35 | 30.73 | 30.73 | 1 | 7.84 |
| 15.35 | 11.25 | 30.73 | 30.73 | 4.1 | 7.84 |
| 11.75 | 10.75 | 23.5 | 46.99 | 1 | 6.02 |
| 11.75 | 7.65 | 23.5 | 46.99 | 4.1 | 6.02 |
| 39.84 | 38.84 | | | 1 | 20.32 |
| 39.84 | 35.74 | | | 4.1 | 20.32 |

D. Final compositions of samples made with enriched B₄C (wt. %)

| | | | | | | Aluminum |
|---|---|---|---|---|---|---|
| MKP | Ash | Fe₂O₃ (sand) | Fe₃O₄ (gravel) | B₄C | H₂O | bar |
| 15.35 | 14.35 | 30.73 | 30.73 | 1 | 7.84 | 10.0 |
| 15.35 | 11.25 | 30.73 | 30.73 | 4.1 | 7.84 | 10.0 |
| 11.75 | 10.05 | 23.5 | 46.99 | 1 | 6.02 | 7.7 |
| 11.75 | 7.65 | 23.5 | 46.99 | 4.1 | 6.02 | 7.7 |

As before the aluminum bars took the place of an equal weight of ash and are 4.5 wt. % elemental enriched boron, >95% boron-10. Also, the weight presence of aluminum bars in the examples in Tables B and D are in addition to the total weight of typical samples (i.e., those without the bars.)

While the invention has been described with reference to details of the illustrated embodiment, these details are not intended to limit the scope of the invention as defined in the appended claims.

The embodiment of the invention in which an exclusive property or privilege is claimed is defined as follows:

1. A method for enhancing the radiation shielding characteristics of phosphate ceramics comprising:
a) providing a ceramic liquor;
b) adding boron to the liquor; and
c) allowing the liquor to cure.

2. The method as recited in claim 1 wherein the boron is in the form of boron compounds selected from the group consisting of natural B₄C, enriched B₄C, boric acid, iron boride, or combinations thereof.

3. The method as recited in claim 1 wherein the boron is a boron isotope selected from the group consisting of boron-10, boron-11, or a combination thereof.

4. The method as recited in claim 2 wherein the concentration of natural B₄C in the ceramic varies from 1 wt. % to 20 wt. %.

5. The method as recited in claim 2 wherein the concentration of enriched B₄C in the ceramic varies from 1 wt. % to 20 wt. %.

6. The method as recited in claim 2 wherein the enriched boron contains greater than 95% boron-10.

7. The method as recited in claim 1 wherein the boron is contained in borated aluminum and the concentration of the borated aluminum in the ceramic liquor varies from 1 wt. % to 20 wt. %.

8. The method as recited in claim 1 wherein the boron is enriched boron selected from the group consisting of elemental boron, boron carbide, boric acid, or a combination thereof.

9. The method as recited in claim 1 wherein shielding is further enhanced with the addition of heavy metals to the liquor.

10. The method as recited in claim 9 wherein the heavy metal is in the form of an oxide selected from the group consisting of Fe₃O₄, Bi₂O₃, Fe₂O₃, and PbO₂.

11. The method as recited in claim 10 wherein the concentration of Bi₂O₃ varies from 1 wt. % to 15 wt. %.

12. The method as recited in claim 10 wherein the concentration of Fe₂O₃ varies from 1 wt. % to 50 wt. %.

13. The method as recited in claim 10 wherein the concentration of Fe₃O₄ varies from 1 wt. % to 50 wt. %.

14. The method as recited in claim 9 wherein the heavy metal is lead, bismuth, iron, or combinations thereof.

15. The method as recited in claim 14 wherein the concentration of Pb metal varies from 5 wt. % to 50 wt. %.

16. A ceramic substrate comprising:
a) a binder further comprising magnesium, potassium, and phosphorus;
b) a means for dissipating heat, said means contacting said binder; and
c) a means for shielding radiation, said shielding means contacting said binder.

17. The substrate as recited in claim 16 wherein the heat dissipating means is integrally formed with the shielding means.

18. The substrate as recited in claim 16 wherein the shielding means comprises boron.

19. The substrate as recited in claim 16 wherein the shielding means is homogeneously dispersed within the binder.

20. The substrate as recited in claim 18 wherein the shielding means for gamma radiation further comprises a heavy metal selected from the group consisting of lead, bismuth, and iron.
